(19) United States
(12) Patent Application Publication
(10) Pub. No.: US 2015/0097382 A1
(43) Pub. Date: Apr. 9, 2015

(54) Latch Guard Device and Method

(71) Applicant: CHRISTOPHER J. BLAWAT, PALMYRA, WI (US)

(72) Inventor: CHRISTOPHER J. BLAWAT, PALMYRA, WI (US)

(21) Appl. No.: 14/509,825

(22) Filed: Oct. 8, 2014

Related U.S. Application Data
(60) Provisional application No. 61/888,342, filed on Oct. 8, 2013.

(51) Int. Cl. E05B 15/02

(52) U.S. Cl. CPC E05B 15/0205
USPC 292/288; 29/428

(57) ABSTRACT

A safety device for use with exteriorly locked doors. The safety device provides a temporary barrier between the latch and the strike plate hole to allow ingress and egress through the door while the door is in a constant locked position. The device includes a strike plate cover, a frame portion, a pull portion, and at least one magnet member.

### RELATED APPLICATIONS

The present invention claims the benefit of co-pending U.S. Provisional Patent Application Ser. No. 61/888,342, filed on 8 Oct. 2013.

### BACKGROUND OF THE INVENTION

Many doors, such as classroom doors, are keyed from only one side. Currently, to lock a typical in swinging classroom door, an adult inside the classroom must have the correct key for each classroom door. In addition, the person locking the door must be outside the room to lock the door. Thus, the person locking the door must step outside of the room and into the hallway to lock the door. During typical operation, this arrangement is problem free. However, in times of distress, for example during an emergency lock-down, the extra step of walking out of the classroom and into the hallway to lock the door from the outside may place the individual in a compromised position. Moreover, this standard locking procedure does not provide a controlled room environment when the door must be quickly locked to secure occupants inside the room during an emergency lock-down situation. Further, it is not practical to keep doors in a constantly locked position. Doors locked at all times may present other security issues. For example, if doors are in a constant lock position any children, staff members, educators, or others with authorized access to the room would first need to knock on the door to gain access. This interrupts learning.

Certain solutions have been designed to remedy this situation. For example, a magnetic strip may be placed over the door strike plate and latch hole. Since the strip covers the latch hole, when the magnetic strip is in place, the door may remain in the locked position and yet freely swing open or closed. To lock the door, the magnetic strip must be removed by a staff member, student, or other approved person to thereby allow the lock to engage the latch hole. While this approach allows the door to be in a constant lock position while also providing access to the room, removal of the magnetic strip again requires opening the door and stepping into the hallway or opening the door during a dangerous lock-down situation, thereby putting the user at risk.

Another product designed to keep locked doors swinging freely includes the use of a thin metal bar that may be moved between locked and unlocked position. When the bar is in a first position it prevents the locked door from closing all the way. When the bar is flipped to a second position the door is allowed to lock. Installation of the metal bar onto a door frame requires a specific amount of space between the door and door frame. Further, depending on installation height, staff and students may need chairs or stools in order to reach the metal bar to move it when required. Moreover, the product is not particularly effective for use with outward swing doors. If this product is used with an outward swing door, the user must step into the hallway, flip the bar, and then step back into the classroom, thereby creating a potential risk to both the user and the room occupants during a lock down situation.

Yet another product created to lock a door in the event of an emergency is a peg and hole arrangement. A peg drops into a hole in the floor when rapid locking is required. This solution is not optimal for several reasons. First, the user must drill holes into the floor to accommodate the pegs. Second, the user must provide a way for security or administration to gain access to the room after the emergency or threat has passed. Since the door is locked by a peg from the inside, an exterior key will not allow entrance from the hallway. This may present a problem due to various laws regarding the locking of classroom doors. For example, and typically, school room doors may not be locked from the inside unless the door has a push button lock that disengages with a turn on the knob from the inside. Further, occupants are not allowed to be locked in a classroom without an accessible exit. Although children may be able to disengage the interior peg after the emergency has passed, they may not reliably do so.

Therefore, a solution is needed to enable a door, such as a classroom door, to be freely opened while the door is locked, but also permit quick and facile locking in the event of an emergency lock-down.

### SUMMARY OF THE INVENTION

The present invention provides a solution to the aforementioned problems and shortcomings by providing a safety device for use with exteriorly locked doors. The device may be adapted for use on both outward swing and inward swing doors. A safety device according to the present invention provides a temporary barrier between the latch and the strike plate hole while the door is in a locked condition to thereby prevent the locked door latch from engaging the strike plate hole. The present device is adapted to attach to a door frame and to provide a temporary barrier over the latch hole. While the device is in place, the door may be in the locked position at all times, while simultaneously permitting ingress and egress to the room. In the event of an emergency lock-down, room occupants may push the door closed, remove the safety device from the strike plate, and thereby allow the locked latch to engage the latch hole. These steps may be taken while the occupants remain in the room and without need to exit the room into the hallway. At the same time, students or other room occupants may transition to their required safe locations within the room. The present invention enables rooms such as classrooms to be controlled in a relatively short time while keeping the user out of the hallway or door frame.

A safety device according to the present invention may preferably include a strike plate cover, a frame portion, a pull portion, and at least one magnet member. The strike plate cover is preferably sized and dimensioned to cover a strike plate of a lock set, and particularly cover the latch hole. The strike plate cover includes a first planar surface, a second planar surface, a first side edge, and second side edge. One of the side edges preferably includes a frame portion extending generally perpendicularly from the plane of the strike plate cover. The frame portion preferably includes a first frame surface and an oppositely disposed second frame surface. At least one of the frame surfaces includes at least one magnet member affixed thereto. The safety device further includes a pull portion. The pull portion extends from one of the frame surfaces, preferably the frame surface opposite the at least one magnet member. Optionally, the device may include a lanyard. When used, one of the ends of the lanyard is affixed to the pull portion, while the opposite end is adapted to be affixed to a door frame. When the safety device is pulled from the strike plate, the lanyard remains affixed to the door frame and thereby allows the device to dangle from the frame to prevent loss. The device may further and optionally include a protrusion on at least one planar surface of the strike plate cover. The protrusion provides additional friction to assist in securing the device to a strike plate while the door is closed.

Another embodiment safety device according to the present invention, and specifically for use with outwardly swinging doors, preferably includes a strike plate cover, an elongated frame portion, a pull portion, and at least one magnet member. Again, the strike plate cover is preferably sized and dimensioned to cover a strike plate of a lock set, and particularly to cover the latch hole. The strike plate cover includes a first planar surface, a second planar surface, a first side edge, and second side edge. One of the side edges includes a connector portion extending generally perpendicularly from the plane of the strike plate cover. An elongated frame portion extends from the connector portion and in a plane parallel to that of the strike plate cover. The frame portion further preferably includes a first frame surface and an oppositely disposed second frame surface. At least one of the frame surfaces includes at least one magnet member affixed thereto. The safety device further includes a pull portion. The pull portion extends from one of the frame surfaces. As in the previous embodiment, the device may optionally include a lanyard to prevent loss when the safety device is removed from the strike plate. The device may also be provided with an adjustment block for use during installation and stability, as will be discussed.

Another embodiment of a safety device according to the present invention, and specifically for use with doors having a crash bar type latch system, may preferably include a strike plate cover, a frame portion, a pull portion, and at least one magnet member. The strike plate cover may further be provided with a hooked end for engagement with the roller member of a crash bar latch system. The strike plate cover is preferably sized and dimensioned to cover a latching mechanism of a crash bar system, with the hooked end particularly engaging the roller member to prevent latching. The strike plate cover includes a first planar surface, a second planar surface, a first side edge, and second side edge. One of the edges includes an angled connector portion extending from the plane of the strike plate cover. A frame portion extends from the connector portion. The frame portion further preferably includes a first frame surface and an oppositely disposed second frame surface. At least one of the frame surfaces includes at least one magnet member affixed thereto. In this embodiment, the pull portion is integrated with the frame portion, as the user simply grasps the frame portion to slide the device away from the latch system to thereby engage the lock. As in previous embodiments, the device may optionally include a lanyard to prevent loss when the device is removed from the strike plate.

### BRIEF DESCRIPTION OF THE DRAWINGS

FIG. 1 is a front perspective view of a safety device according to the present invention.

FIG. 2 is a back perspective view of the safety device illustrated in FIG. 1.

FIG. 3 is a perspective side view of the safety device illustrated in FIGS. 1 and 2.

FIG. 4 is a front plan view of the device illustrated in FIGS. 1-3.

FIG. 5 is a rear plan view of the device illustrated in FIGS. 1-4.

FIG. 6 is a left side view of the device illustrated in FIGS. 1-5.

FIG. 7 is a right side view of the device illustrated in FIGS. 1-6.

FIG. 8 is a top view of the device illustrated in FIGS. 1-7.

FIG. 9 is a bottom view of the device illustrated in FIGS. 1-8.

FIG. 10 is a view of a stamping of the device illustrated in FIGS. 1-9 in flat form to be bent to into the shape illustrated in FIGS. 1-9.

FIG. 11 is a perspective front view of another embodiment of a safety device according to the present invention.

FIG. 12 is a back perspective view of the device illustrated in FIG. 11.

FIG. 13 is a front plan view of the device illustrated in FIGS. 11 and 12.

FIG. 14 is a rear plan view of the device illustrated in FIGS. 11-13.

FIG. 15 is a left side view of the device illustrated in FIGS. 11-14.

FIG. 16 is a right side view of the device illustrated in FIGS. 11-15.

FIG. 17 is a top view of the device illustrated in FIGS. 11-16.

FIG. 18 is a bottom view of the device illustrated in FIGS. 11-17.

FIG. 19 is a back perspective view, similar to that of FIG. 12, but showing an optional adjustment bar.

FIG. 20 is a front perspective view of the device illustrated in FIG. 19 and showing use of the adjustment bar.

FIG. 21 is a rear perspective view of the device, similar to that of FIG. 12, but showing an alternative magnet placement.

FIG. 22 is a perspective front view of another embodiment of a safety device according to the present invention.

FIG. 23 is a front plan view of the device illustrated in FIG. 22.

FIG. 24 is a bottom view of the device illustrated in FIGS. 22-23.

FIG. 25 is a rear plan view of the device illustrated in FIGS. 22-24.

FIG. 26 is a top view of the device illustrated in FIGS. 22-25.

FIG. 27 is a left side view of the device illustrated in FIGS. 22-26.

FIG. 28 is a right side view of the device illustrated in FIGS. 22-27.

FIG. 29 is a view of the device illustrated in FIGS. 1-10 in place on a door frame and strike plate during use.

FIG. 30 is a fragmentary view similar to that of FIG. 29 but showing the door in the open position.

FIG. 31A is a fragmentary view similar to that of FIG. 30 but showing the door in the closed position and prior to device removal.

FIG. 31B is a cross sectional view of the device illustrated in FIGS. 1-10 in place with lock components positioned as in FIG. 31A, and taken along lines 31B-31B thereof.

FIG. 32A is a fragmentary view similar to that of FIG. 31A and showing the door in the closed position during device removal.

FIG. 32B is a cross sectional view of the device with lock components positioned as in FIG. 32A during device removal, and taken along lines 32B-32B thereof.

FIG. 33 is a fragmentary view, similar to that of FIGS. 31A and 32A but showing the device removed and hanging from a lanyard.

FIG. 34A is a view of the device illustrated in FIGS. 11-18 in place on a door frame and strike plate during use on an outward swing door.

FIG. 34B is a cross sectional view of the device in place with lock components positioned as shown in FIG. 34A and taken along lines 34B-34B thereof.

FIG. 35 is a fragmentary enlarged view of the device illustrated in FIGS. 34A, 34B but with the door in the open position.

FIG. 36 is a fragmentary view, similar to that of FIG. 34A, but showing the device during disengagement.

FIG. 37A is a view of the device illustrated in FIGS. 22-28 in place during use on a door frame and door having a crash bar latch system.

FIG. 37B is a cross sectional view of the device in place and with latching mechanism positioned as in FIG. 37A, and taken along lines 37B-37B thereof.

FIG. 38 is a view similar to that of FIG. 37A, but showing the device during disengagement.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

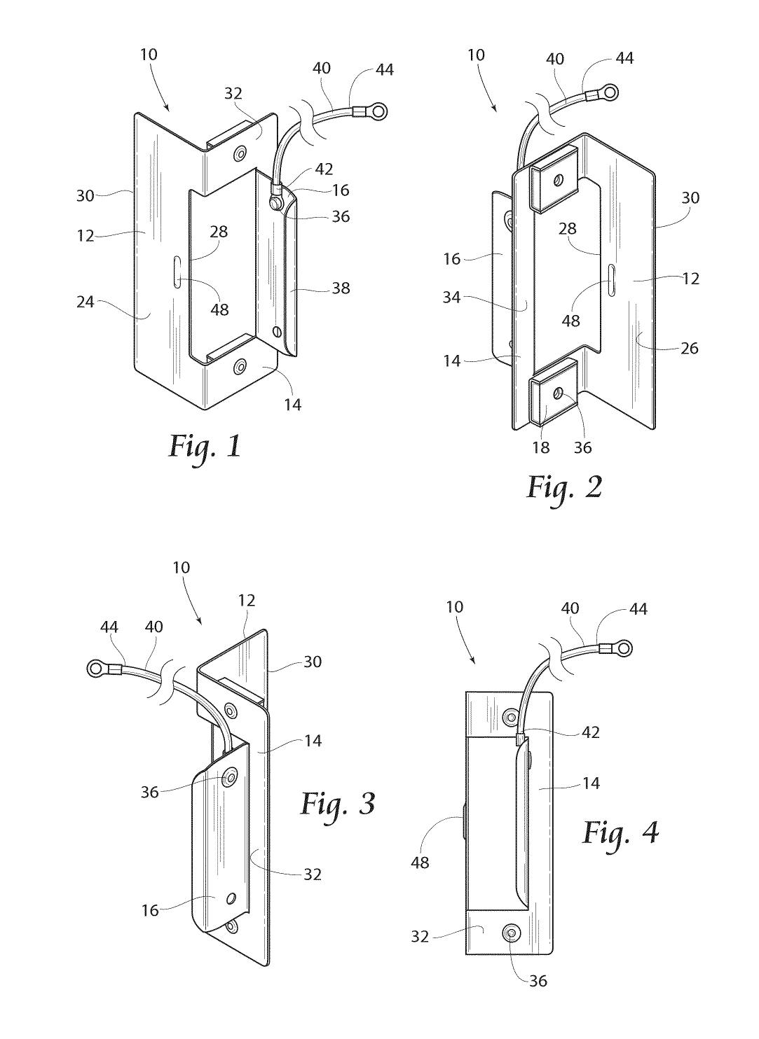

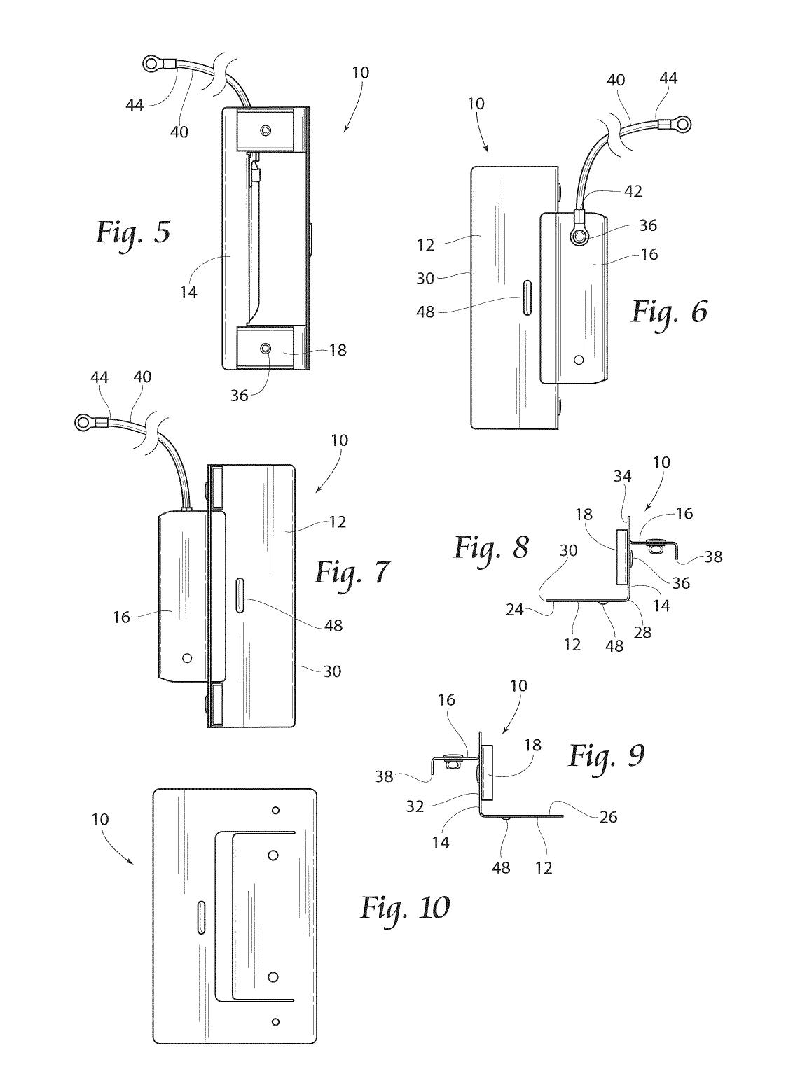

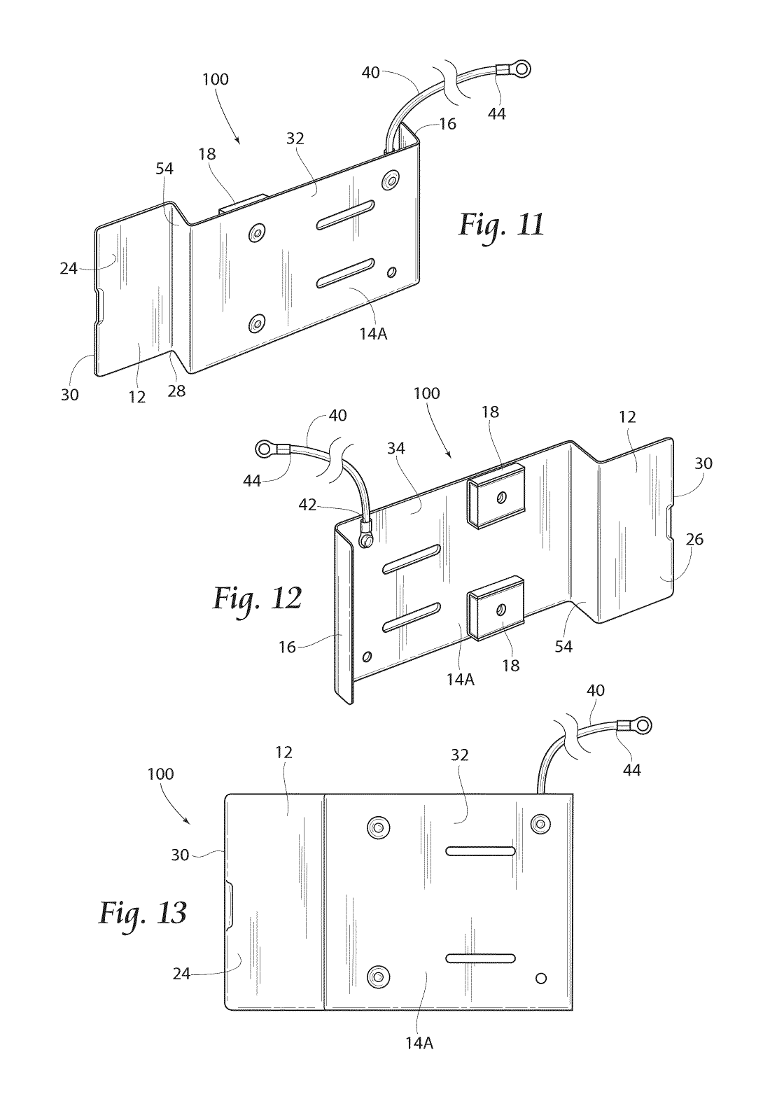

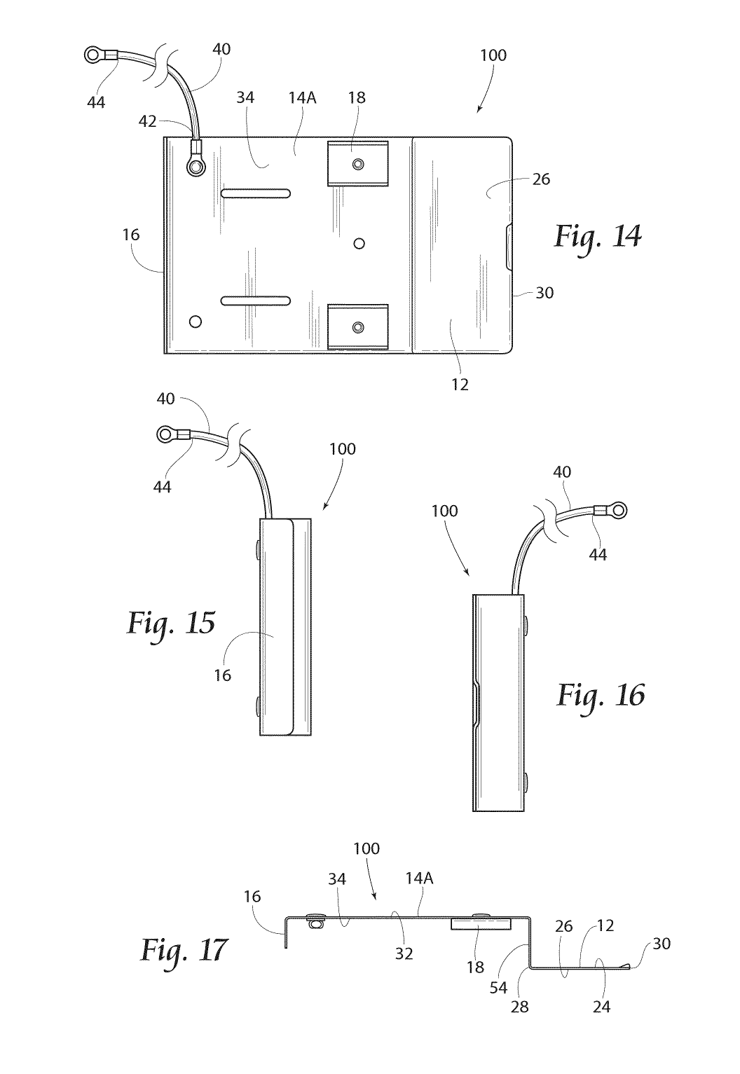

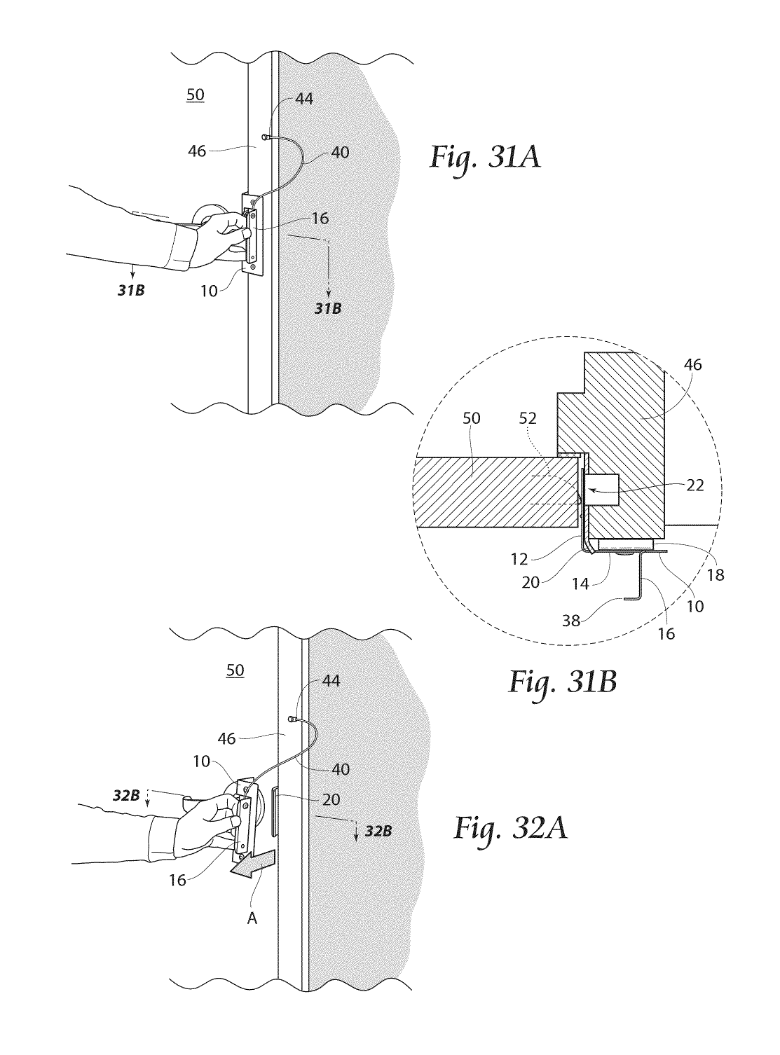

With attention to FIGS. 1-10, an embodiment of a safety device 10 according to the present invention may be seen. As shown, the device 10 preferably includes a strike plate cover 12, a frame portion 14, a pull portion 16, and at least one magnet member 18. The strike plate cover 12 is preferably sized and dimensioned to cover a strike plate 20 (see FIGS. 31B-33) of a lock set, and particularly to cover the latch hole 22 (see FIG. 31B). The strike plate cover 12 preferably includes a first planar surface 24, a second planar surface 26, a first side edge 28, and second side edge 30. One of the side edges 28, 30 preferably includes a frame portion 14 extending generally perpendicularly from a plane of the strike plate cover 12. The frame portion 14 preferably includes a first frame surface 32 and an oppositely disposed second frame surface 34. At least one of the frame surfaces 32, 34 includes at least one magnet member 18 affixed thereto. The magnet member 18 may be affixed by any fastening means that is satisfactory to affix the magnet 18 to the device 10 and resist removal during use, such as the rivet 36 shown. Moreover, a magnet member 18 for use with the present invention is preferably of a type being strong enough to affix the device 10 to a magnetically attractive ferrous material.

With further attention to FIGS. 1-10 and 31A-33, the safety device 10 may be seen to include a pull portion 16. The pull portion 16 extends generally perpendicularly from one of the frame surfaces 32, 34, preferably the frame surface 32, 34 opposite the magnet member 18, seen as frame surface 32 in these views. The pull portion 16 may optionally include a flanged end 38 for ease in gripping when the device 10 is removed, as will be discussed. Optionally, the device 10 may also include a lanyard 40 having a first end 42 and a second end 44. In use, one the ends 42, 44 of the lanyard 40 is affixed to the pull portion 16, while the opposite end 42, 44 is adapted to be affixed to a door frame 46. An end 42, 44 of the lanyard 40 may be affixed to the pull portion 16 by any suitable fastener, such as the rivet 36 shown, while the opposite end 42, 44 is attached to a door frame 46 in the same manner as by a rivet 36, screw, or other acceptable fastener (not seen in these views). When the safety device 10 is pulled from the strike plate 20, the lanyard 40 remains affixed to the door frame 46 to thereby allow the device 10 to dangle from the frame 46 and prevent loss of the device 10. The device 10 may be made of any suitably rigid and wear resistant material, such as a metal. When formed of metal, the device 10 may be formed from a metal stamping such as that shown in FIG. 10 and bent to the preferred configuration.

The device 10 may further and optionally include a protrusion 48 on at least one planar surface 24, 26 of the strike plate cover 12. The protrusion 48 provides additional friction to assist in securing the device 10 to a strike plate 20 while the door 50 is closed.

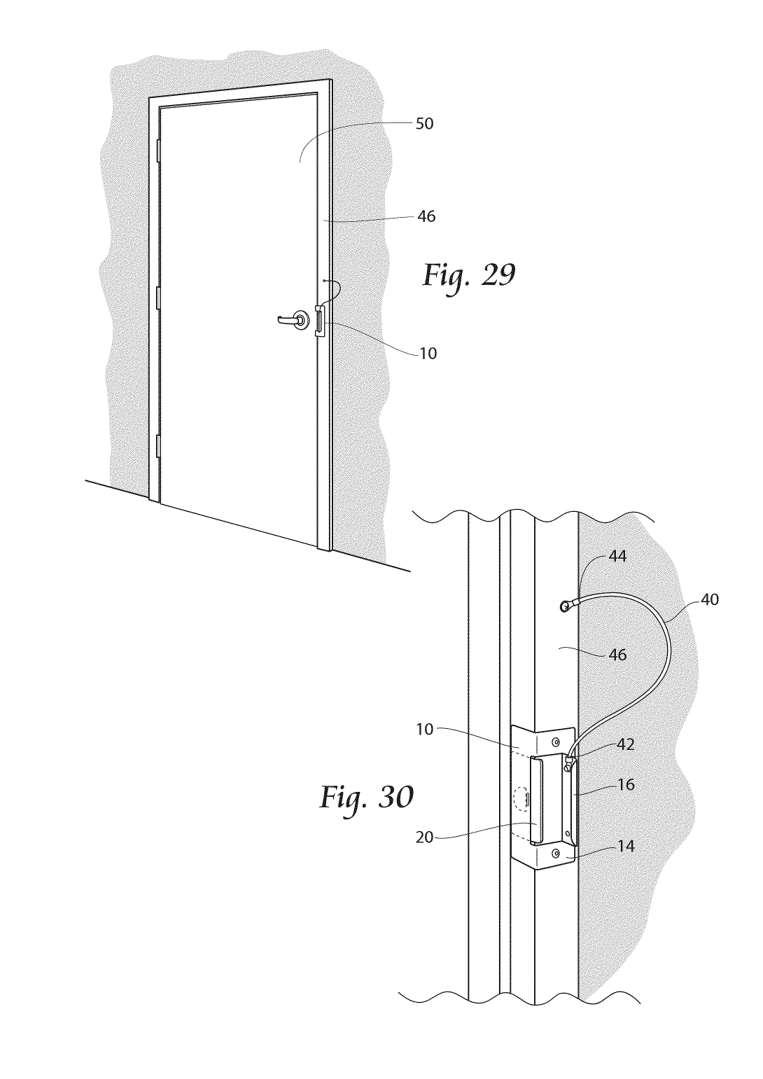

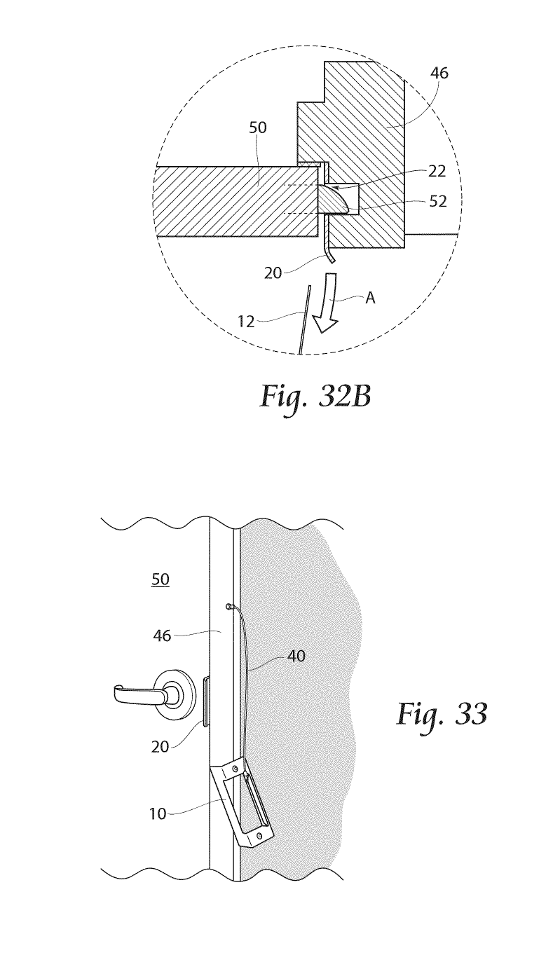

With specific attention now to FIGS. 29-33, use of the device 10 may be seen. As shown, the device 10 may be normally installed on a door frame 46, with the strike plate cover 12 placed adjacent and over the strike plate 20 and latch hole 22 of a door 50. The door frame 46 is of a magnetically attractive ferrous material such that the magnet member 18 on the frame portion 14 is attracted to and holds the device 10 against the door frame 46. When the device 10 is installed as is shown in FIGS. 29-31B, the door 50 may be in a constant locked position, with the strike plate cover 12 preventing the latch 52 from engaging in the latch hole 22 and locking the door 50. In this manner, the device 10 may remain in place and the door 50 will open freely despite it being in a locked position. When quick locking of the door 50 is desired, as for example, during an emergency lockdown, an authorized user may simply grasp the pull portion 16, as is seen in FIGS. 32A, 32B, and move the device 10 in the direction of arrow A. With the device 10 and its strike plate cover 12 removed, the latch 52 is able to engage the latch hole 22, and the door 50 is locked. As is seen in FIG. 33, the device 10, when provided with a lanyard 40, dangles from the door frame 46.

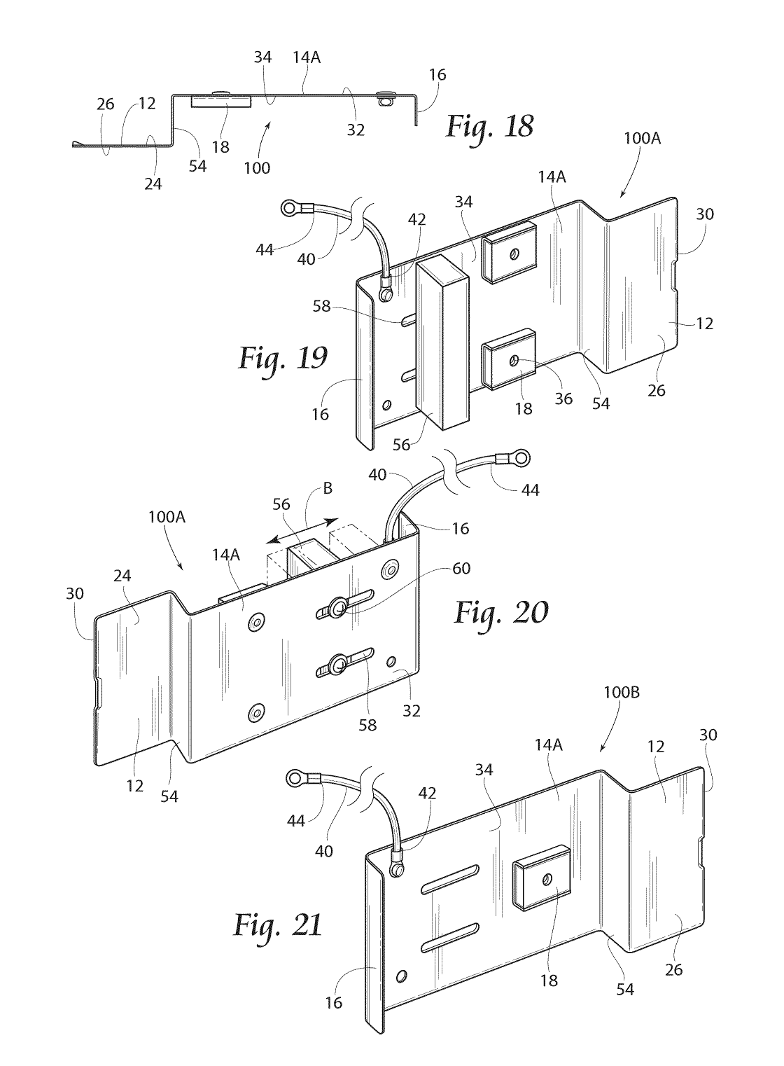

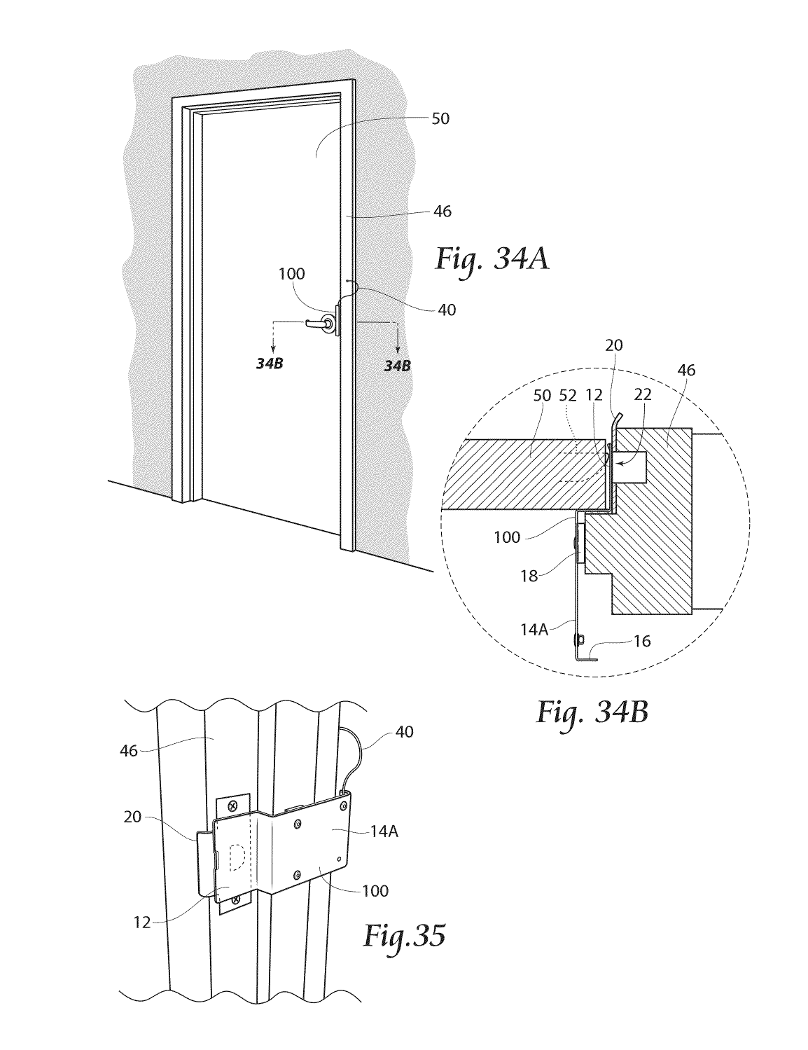

With attention now to FIGS. 11-21 and 34A-36, another embodiment of a safety device 100, 100A, 100B according to the present invention may be seen. The device 100, 100A, 100B illustrated in these Figures is for use with outwardly swinging doors 50. As shown, and similar to the previously described device 10, the device 100, 100A, 100B shown in these views preferably includes a strike plate cover 12, an elongated frame portion 14A, a pull portion 16, and at least one magnet member 18. The strike plate cover 12 is preferably sized and dimensioned to cover a strike plate 20 (see FIGS. 34B and 35) of a lock set, and particularly to cover the latch hole 22 (see FIG. 34B). The strike plate cover 12 preferably includes a first planar surface 24, a second planar surface 26, a first side edge 28, and second side edge 30. One of the side edges 28, 30 preferably includes a connector portion 54 extending generally perpendicularly from a plane of the strike plate cover 12. An elongated frame portion 14A extends generally perpendicularly from the connector portion 54 and in a plane parallel to that of the strike plate cover 12. The frame portion 14A further preferably includes a first frame surface 32 and an oppositely disposed second frame surface 34. At least one of the frame surfaces 32, 34 (seen as surface 34 in these views) includes at least one magnet member 18 affixed thereto. The magnet member 18 may be affixed by any fastening means that is satisfactory to affix the magnet 18 to the device 100, 100A, 100B and resist removal during use, such as the rivet 36 shown, although other fastening means may be envisioned without departing from the invention. Moreover, a magnet member 18 for use with the present invention is preferably of a type being strong enough to affix the device 100, 100A, 100B to a magnetically attractive ferrous material, such as a door frame 46.

With further attention to FIGS. 11-21 and 34A-36, the safety device 100, 100A, 100B may be seen to include a pull portion 16. The pull portion 16 extends generally perpendicularly from one of the frame surfaces 32, 34, preferably the frame surface 32, 34 adjacent the magnet member 18, seen as surface 34 in these views. As in the previous embodiment, the device 100, 100A, 100B may optionally include a lanyard 40 having a first end 42 and a second end 44. In use, one of the ends 42, 44 of the lanyard 40 is affixed to the frame portion 14A, while the opposite end 42, 44 is adapted to be affixed to a door frame 46. An end 42, 44 of the lanyard 40 may be affixed to the frame portion 14A by any suitable fastener, such as the rivet 36 shown, while the opposite end 42, 44 is attached to a door frame 46 in the same manner as by a rivet 36, screw, or other acceptable fastener. When the safety device 100, 100A, 100B is removed from the strike plate 20 when not in use, the lanyard 40 remains affixed to the door frame 46 to thereby allow the device 100, 100A, 100B to dangle from the frame 46 to prevent loss of the device 100, 100A, 100B.

With attention now to FIGS. 19 and 20, the device 100A may be provided with at least one adjustment block 56 for use during installation and stability. As is shown, the frame portion 14A may include a plurality of adjustment slots 58. The adjustment slots 58 are arranged to slidingly accept screws 60 or other fasteners for the adjustment block 56. In use, the adjustment block 56 may be moved along the slots 58 in the direction of arrow B (see FIG. 20) to thereby locate the block 56 adjacent a door frame 46. Once the block 56 is snug against a door frame 46, and the device 100A is located properly against the strike plate 20, the screws 60 may be tightened to prevent further movement.

FIG. 21 illustrates an alternative magnet member 18 arrangement, wherein a single magnet 18 may be used. It is to be understood that any number or configuration of magnet members 18 may be used without departing from the invention.

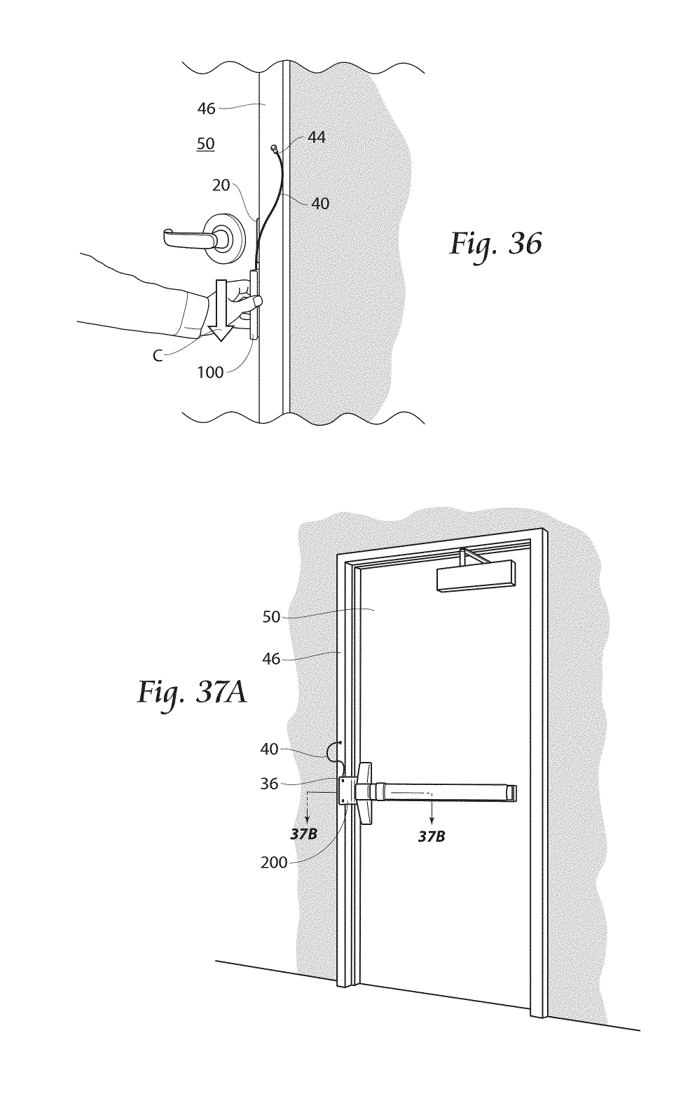

With specific attention now to FIGS. 34A-36, use of the device 100, 100A, 100B may be seen. As shown, the device 100, 100A, 100B may be normally installed on a door frame 46, of an outward swing door 50 with the strike plate cover 12 placed adjacent and over the strike plate 20 and latch hole 22 of a door 50. The door frame 46 is of a magnetically attractive ferrous material such that the magnet member 18 on the frame portion 14A is attracted to and holds the device 100, 100A, 100B against the door frame 46. When the device 100, 100A, 100B is installed as is shown in FIGS. 34A-35, the door 50 may be in a constant locked position, with the strike plate cover 12 preventing the latch 52 from engaging in the latch hole 22 and locking the door 50. In this manner, the device 100, 100A, 100B may remain in place and the door 50 will open freely despite it being in a locked position. When quick locking of the door 50 is desired as for example, during an emergency lockdown, an authorized user may simply grasp the pull portion 16 as is seen in FIG. 36, and move the device 100, 100A, 100B in the direction of arrow C. With the device 100, 100A, 100B and its strike plate cover 12 removed, the latch 52 is able to engage the latch hole 22 and the door 50 is locked. When the device 100, 100A, 100B is optionally provided with a lanyard 40, the device 100, 100A, 100B will dangle from the door frame 46 when not in use, as is shown in FIG. 33.

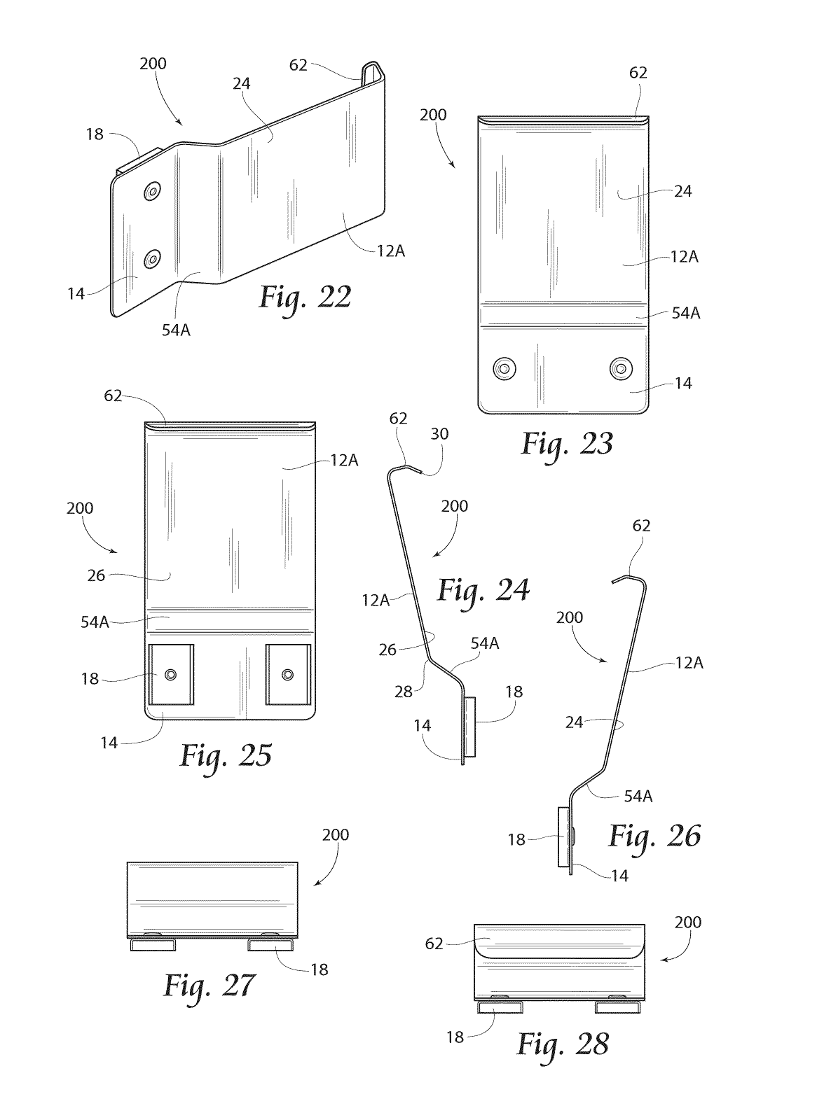

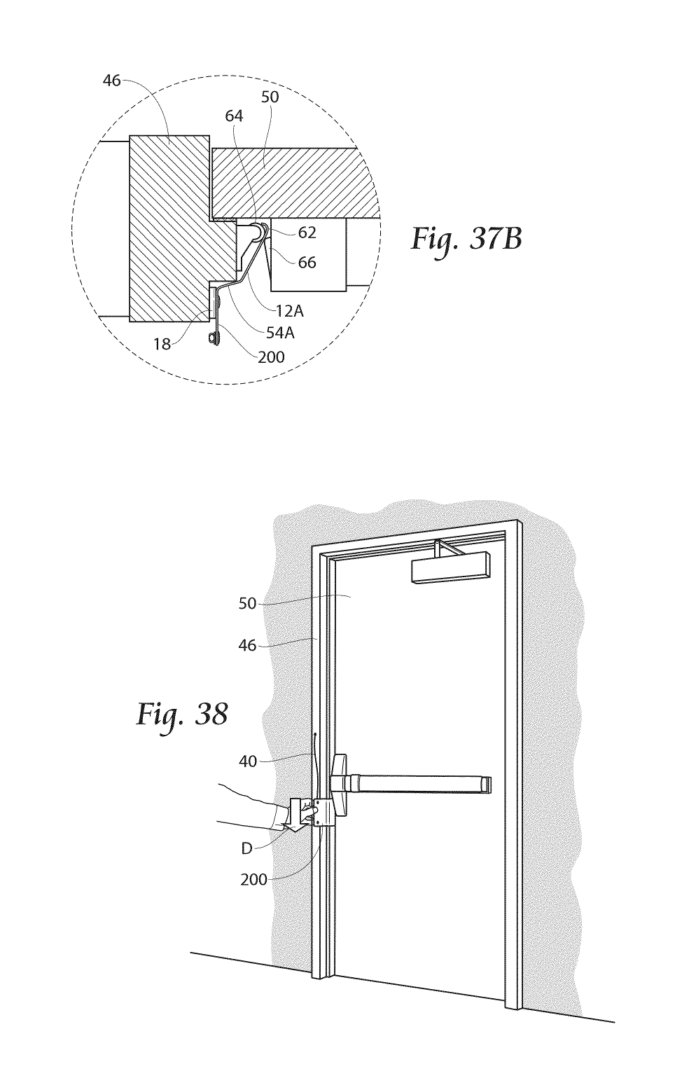

FIGS. 22-28 and 37A-38 illustrate another embodiment of a safety device 200 according to the present invention, and specifically for use with doors 50 having a crash bar type latch system. As in the previously described embodiments, the device 200 illustrated in these views may preferably include a strike plate cover 12A, a frame portion 14, a pull portion 16, and at least one magnet member 18. As seen, the strike plate cover 12A may further be provided with a hooked end 62 for engagement with a roller member 64 of a crash bar latch system (see FIG. 37B). The strike plate cover 12A is preferably sized and dimensioned to cover a catch mechanism 66 of a crash bar system, with the hooked end 62 particularly engaging the roller member 64 to prevent latching. The strike plate cover 12A preferably includes a first planar surface 24, a second planar surface 26, a first side edge 28, and second side edge 30. One of the edges 28, 30 terminates in an angled connector portion 54A extending from the plane of the strike plate cover 12A. A frame portion 14 extends from the connector portion 54A. The frame portion 14 further preferably includes a first frame surface 32 and an oppositely disposed second frame surface 34. At least one of the frame surfaces 32, 34 includes at least one magnet member 18 affixed thereto. As in the previous embodiments, the magnet member 18 may be affixed by any fastening means that is satisfactory to affix the magnet 18 to the device 200 and resist removal during use, such as the rivet 36 shown. Moreover, a magnet member 18 for use with the present invention is preferably of a type being strong enough to affix the device 200 to a magnetically attractive ferrous material.

As may be further seen in the views of FIGS. 22-28, and 37A-38, the pull portion 16 discussed with regard to the previous embodiments is integrated with the frame portion 14. With specific reference to FIG. 38, the user simply grasps the frame portion 14 and slides the device 200 in the direction of arrow D, away from the latch system, to thereby allow the catch 66 to engage with the roller member 64. As in the previous embodiments, the device 200 may optionally include a lanyard 40 having a first end 42 and a second end 44. When used, one the ends 42, 44 of the lanyard 40 is affixed to the frame portion 14, while the opposite end 42, 44 is adapted to be affixed to a door frame 46. An end 42, 44 of the lanyard 40 may be affixed to the frame portion 14 by any suitable fastener, such as the rivet 36 shown, while the opposite end 42, 44 is attached to a door frame 46 in the same manner as by a rivet 36, screw, or other acceptable fastener. When the safety device 200 is removed from the strike plate 20, the lanyard 40 remains affixed to the door frame 46 to thereby allow the device 200 to dangle from the frame.

FIGS. 37A-38 illustrate use of the device 200. As shown, the device 200 may be normally installed on a door frame 46, of an outward swing door 50 having a crash bar locking system. When installed, the strike plate cover 12 is placed adjacent to and over the roller member 64 and catch 66 of a door 50 having a crash bar locking system. The door frame 46 is of a magnetically attractive ferrous material such that the magnet member 18 on the frame portion 14 is attracted to and holds the device 200 against the door frame 46. When the device 200 is installed as shown in FIGS. 37A-38, the door 50 may be in a constant locked position, with the strike plate cover 12 preventing the catch 66 from engaging the roller member 64 and locking the door 50. In this manner, the device 200 may remain in place and the door 50 will open freely despite it being in a locked position. When quick locking of the door 50 is desired, as for example during an emergency lockdown, an authorized user may simply grasp the frame portion 14 as is seen in FIG. 38, and move the device 200 in the direction of arrow D. With the device 200 and its strike plate cover 12 removed, the catch 66 is able to engage the roller member 64 and the door 50 is locked. As in the previous embodiments, if the device 200 is provided with a lanyard 40, it will dangle from the door frame 46 when not in use.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A safety device for removably covering a strike plate of a door lock set, said device including:
a strike plate cover;
a frame portion;
a pull portion; and
at least one magnet member.

2. The device of claim 1 wherein said strike plate cover is sized and dimensioned to cover said strike plate of said lock set.

3. The device of claim 2 wherein said strike plate cover includes a first planar surface, a second planar surface, a first side edge, and second side edge.

4. The device of claim 3 wherein said frame portion extends perpendicularly from one of said first side edge and said second side edge.

5. The device of claim 4 wherein said frame portion includes a first frame surface and an oppositely disposed second frame surface.

6. The device of claim 5 wherein said at least one magnet member is affixed to one of said first frame surface and said second frames surface.

7. The device of claim 6 further including a pull portion.

8. The device of claim 7 wherein said pull portion extends from one of said first frame surface and said second frame surface.

9. The device of claim 8 wherein said pull portion includes a flanged end.

10. The device of claim 8 further including a lanyard, said lanyard having a first end and a second end, wherein one of said first end and said second end is affixed to said pull portion.

11. The device of claim 8 further including a protrusion on at least one of said first planar surface and said second planar surface.

12. The device of claim 3 wherein in one of said first side edge and said second side edge includes a perpendicularly extending connector portion and wherein said frame portion extends perpendicularly from said connector portion.

13. The device of claim 12 wherein said frame portion further includes a first frame surface and an oppositely disposed second frame surface, and wherein said at least one magnet member is affixed to one of said first frame surface and said second frame surface.

14. The device of claim 13 further including a pull portion.

15. The device of claim 14 wherein said pull portion extends perpendicularly from one of said first frame surface and said second frame surface.

16. The device of claim 15 further including a lanyard, said lanyard having a first end and a second end, wherein one of said first end and said second end is affixed to said frame portion.

17. The device of claim 3 wherein one of said first side edge and said second side edge terminates in an angled connector portion, and an opposite of said first side edge and said second side edge includes a hooked end.

18. The device of claim 17 wherein said frame portion extends from said connector portion; said frame portion including a first frame surface and an oppositely disposed second frame surface, and wherein said at least one magnet member is affixed to one of said first frame surface and said second frame surface.

19. A method for removably covering a door frame strike plate of a door lock set including the steps of:
providing a safety device, said safety device including a strike plate cover, a frame portion, a pull portion, and at least one magnet member, wherein said strike plate cover is sized and dimensioned to cover said strike plate of said lock set;
positioning said strike plate cover over said strike plate;
positioning said frame portion adjacent to said door frame; and
attaching said at least one magnet member to said door frame.
